(19) United States
(12) Patent Application Publication
(10) Pub. No.: US 2001/0036210 A1
(43) Pub. Date: Nov. 1, 2001

(54) Method and a coupling to change the wavelength of an optical transmitter in a system using wavelength division multiplexing

(75) Inventor: Ari Salomaa, Espoo (FI)

Correspondence Address: Michael B. Lasky, Altera Law Group, Suite 100, 6500 City West Parkway, Minneapolis, MN, 55344-7701, US

(73) Assignee: Nokia Networks Oy

(21) Appl. No.: 09/864,644

(22) Filed: May 23, 2001

Related U.S. Application Data
(63) Continuation of application No. PCT/FI99/01017, filed on Dec. 8, 1999.

(30) Foreign Application Priority Data
Dec. 31, 1998 (FI) 982843

(51) Int. Cl. H01S 3/13; H01S 3/04

(52) U.S. Cl. 372/32

(57) ABSTRACT

The invention is based on the idea that wavelength of a laser transmitter in a WDM system can be changed in a controlled fashion by inducing an accurately pre-defined change in the cooler control current TEC. This, in turn, effects a controlled change in the heating or cooling operation of the cooler. As a result, a predetermined change takes place in the wavelength of the light generated by the laser. The temperature control circuit ensures that the laser temperature and, thus, wavelength, are maintained exactly at the new value. For each desired wavelength, a parameter set consisting of a pre-set laser temperature value, a laser power value and laser modulation bias values has been saved in storage in advance. When the laser wavelength is to be changed, the parameter values corresponding to the wavelength are retrieved from the storage and fed to the laser. Retrieval and feeding can be pre-programmed or carried out manually.

### FIELD OF THE INVENTION

The present invention relates generally to optical transmission systems using Wavelength Division Multiplexing and specifically to the optical transmitter used in such systems.

### BACKGROUND

Wavelength Division Multiplexing (WDM) is an efficient way of multiplying the capacity of optical fibre. In wavelength division multiplexing, several independent transmitter-receiver pairs use the same fibre, with each pair operating on a dedicated wavelength.

FIG. 1 illustrates the principle of multiplexing. The system used as an example features four channels that use the wavelengths λ₁, λ₂, λ₃ and λ₄ respectively. The transmission and reception channels are on separate optical fibres. At each end of the optical transmission line, there are four transmitter-receiver pairs of which the transmitter is generally denoted by the symbol Tx and the receiver by the symbol Rx. Transmitter TX1 transmits on wavelength λ₁ and receiver RX1 receives on the same wavelength but from a fibre that is different from the fibre to which the transmitter transmits. All the other pairs use their dedicated wavelengths in a similar fashion.

The wavelengths generated by the transmitters at the left-hand end of fibre 8 are mixed in the optical multiplexer 1 and then passed on to the same optical fibre 8. The modulation bandwidth of each source is narrower than the gap between the wavelengths, so that the spectra of the modulated signals will not overlap. Similarly, the wavelengths generated by the transmitters at the right-hand end of fibre 9 are mixed in the optical multiplexer 3 and then passed on to the same optical fibre 9.

The WDM multiplexers 2 and 4 at the opposite ends of the fibres separate the individual spectral components of the mixed signal from one another. Each of these signals are detected by the dedicated receivers RX1, . . . RX4.

A narrow wavelength window on a certain wavelength range is assigned to each signal. A typical example is a system where the signals are on the 1550 nm wavelength range, so that the wavelength of the first signal is 1557.36 nm, that of the second signal 1554.13 nm, that of the third 1550.92 nm, and that of the fourth 1547.72 nm. The frequency raster corresponding to the wavelength raster is then 200 GHz. ITU-T (the International Telecommunications Union) has standardised the frequencies to be used on the bandwidth, so that the bandwidth starts from 191.5 THz (1565.50 nm) and extends up to 195.9 THz (1530.33) in 100 GHz steps.

The transmitter can consist of a separate laser unit that is available for various wavelength windows, so that the wavelength range specified by ITU-T can be covered. With WDM systems, it is important that the wavelength of the light wave generated by the transmitter remains sufficiently stable. For this reason, a wavelength stabilisation system will be included in the transmitter.

FIG. 2 illustrates the responsive electrical connection for the laser used in the transmitter. The main components are actual laser diode LD, thermistor 21 (NTC resistor) and cooler 22. Cooler operation is based on creating a temperature difference by means of an electrical current. In addition, the chip may include monitor 23 that detects laser light. Usually, it is located at the end opposite to the laser output opening, where it measures the amount of light emitted by the laser. This piece of information is used to adjust the laser output power to the desired level. Although the figure shows an electrical connection between the laser and the monitor, such a connection is not necessarily required.

The most important single factor affecting the laser's wavelength is its temperature, and therefore the chip features a means for maintaining the temperature as stable as possible. Manufacturers indicate in their specifications the permitted temperature range for the casing, TCASE, which is typically −20, . . . , +70° C. The casing temperature is slightly higher than the ambient temperature, T_{AMBIENT}, and the term ‘external temperature’ may refer to either. Within this external temperature range, it is possible to maintain the temperature of the actual laser more or less accurately at the nominal temperature, such as +25° C., using a stabilisation circuitry. This maintains the specified wavelength window and optical power, provided that the electric currents and voltages comply with the rated values.

Resistance and temperature-dependence data are specified for the thermistor at the nominal temperature. For cooler 22, its cooling capacity, maximum TEC voltage and maximum TEC current are specified. The cooling capacity indicates the maximum permitted temperature difference between the nominal laser temperature (such as +25° C.) and the ambient temperature. Typically, this value is 45° C. The maximum TEC voltage is the maximum permissible voltage over the cooler, and the maximum TEC current is the maximum permissible current through the cooler. The cooler is designed to cool the laser unit when the current passes through it in one direction and to heat it when the current passes in the opposite direction. Additionally, the element may be grounded through one terminal, in which case an increase in the current level heats the laser unit and a decrease in the current level allows the chip to cool off.

FIG. 3 shows a known principal coupling for stabilising the laser using an external connection. The circuit board on which transmitters are located includes temperature regulator block 31 for the laser. Despite the fluctuations in the ambient temperature, T_{AMBIENT}, the laser temperature, T_{LASER}, must remain constant. The laser temperature is measured by the thermistor and a voltage proportional to the temperature is supplied to the first input of amplifier 33. A constant reference voltage, V_{REF}, is present at the other input. The voltage, V_{SET}, is specified for the first input so as to ensure that V_{SET}=V_{REF} at the rated laser values. Then, the thermistor resistance has a certain value that is here referred to as the set value.

When the temperature exceeds or falls below the nominal value, the thermistor resistance changes and the amplifier output generates a voltage, the level of which is proportional to the temperature deviation. If necessary, the voltage from the output is supplied to current amplification circuitry 33, which amplifies the current that cools or heats laser LD. The other end of the cooler is connected to TEC Current output of regulator block 31. If the temperature exceeds the nominal value, such as 25° C., the regulator block decreases the TEC current, whereupon cooler 32 cools the chip on which laser LD is located, and thus the laser itself. Conversely, if the temperature falls below the nominal value, the regulator block increases the TEC current, whereupon the laser temperature increases. Heating/cooling are continuous processes designed to maintain the temperature difference, T_{CASE}−T_{LASER}, constant. In the equilibrium state, a constant current passes through the cooler.

In the transmitters used in systems that make use of wavelength division multiplexing, each transmission wavelength is generated by a dedicated laser each of which incorporates a dedicated wavelength stabilisation connection. This solution has a number of drawbacks. First, the greater the number of wavelengths used, the higher the number of lasers and their ancillary circuits on the circuit board. As a result, the manufacturing costs and space requirements on the board increase. Second, if it is necessary to change the wavelength of the light generated by one or more lasers, these lasers need to be detached from the board and replaced with new lasers capable of producing the desired wavelength. Third, a dedicated board needs to be made for each channel combination.

The objective of the present invention is to provide an adjustable laser that eliminates the drawbacks described above. An adjustable laser generates more than one wavelength within a specified wavelength range and, thus, it can be used as a transmitter for as many channels as the laser is capable of generating wavelengths.

This objective is achieved with definitions described in the independent patent claims.

### A BRIEF SUMMARY OF THE INVENTION

The idea of the present invention is that the temperature regulating system, that is used for maintaining the laser temperature exactly at the predefined value, can also be used for controlling the laser temperature and thus the wavelength it produces. By decreasing the laser temperature, it is possible to reduce it from the nominal value exactly so much that the wavelength of the light it generates changes to the adjacent channel. Conversely, the laser temperature can be increased by increasing the set temperature by an amount that makes the wavelength of the light generated by the laser change to the next channel higher up. The temperature is changed by inducing an exact pre-defined change in the cooler control TEC. This, in turn, will cause a controlled change in the heating or cooling operation of the cooler, with the result that the laser temperature changes by the pre-defined amount. Consequently, the desired change in the wavelength of the light generated by the laser takes place. The extra control signal will retain its current value, while the temperature control circuit will ensure that the temperature is maintained exactly at this new value.

A preferred solution to effect extra control is to save, in a nonvolatile storage area, a parameter set for each desired wavelength, said parameters consisting of the pre-set laser temperature control value, the pre-set laser power value and the pre-set laser modulation range. The power supplied to the laser, which defines the light intensity, and the modulation range value, which refers to the bias values for the upper and lower modulation limits, affect the laser temperature, and therefore if the temperature value is changed, it is also necessary to change these values. If the laser wavelength is to be changed, the parameters corresponding to that particular wavelength are retrieved from storage and fed to the laser. Retrieval and feeding may be pre-programmed in the system, or switches may be used if the system is to be controlled manually.

### LIST OF DRAWINGS

The invention is explained in more detail with reference to the enclosed schematic drawings where

FIG. 1 shows a WDM transmission system;

FIG. 2 shows a schematic of the electrical connection of the laser;

FIG. 3 illustrates one connection for laser wavelength stabilisation, and;

FIG. 4 shows a connection in accordance with the invention.

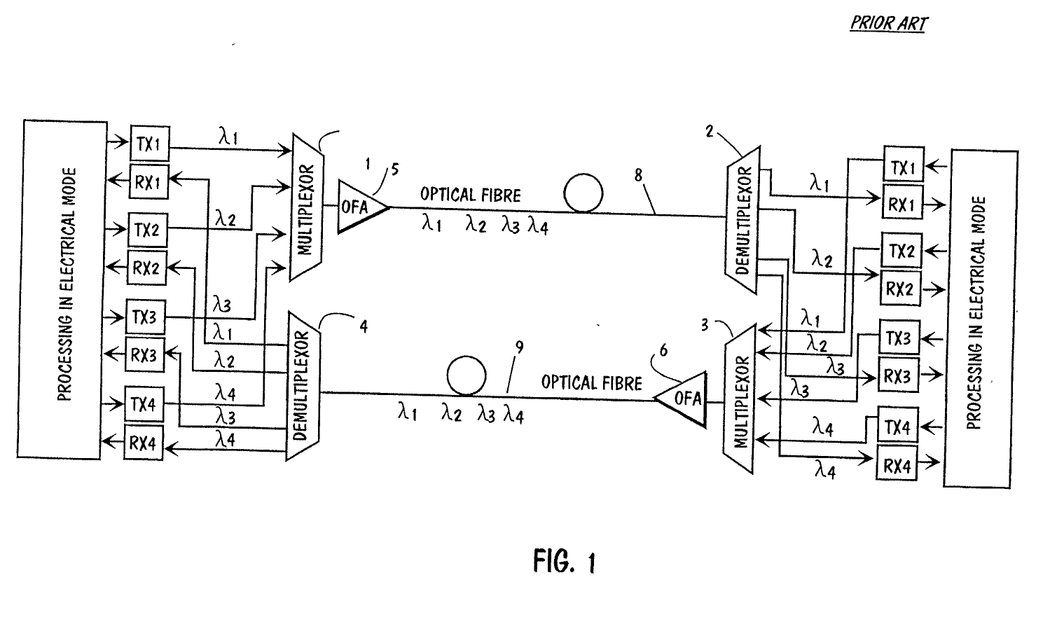

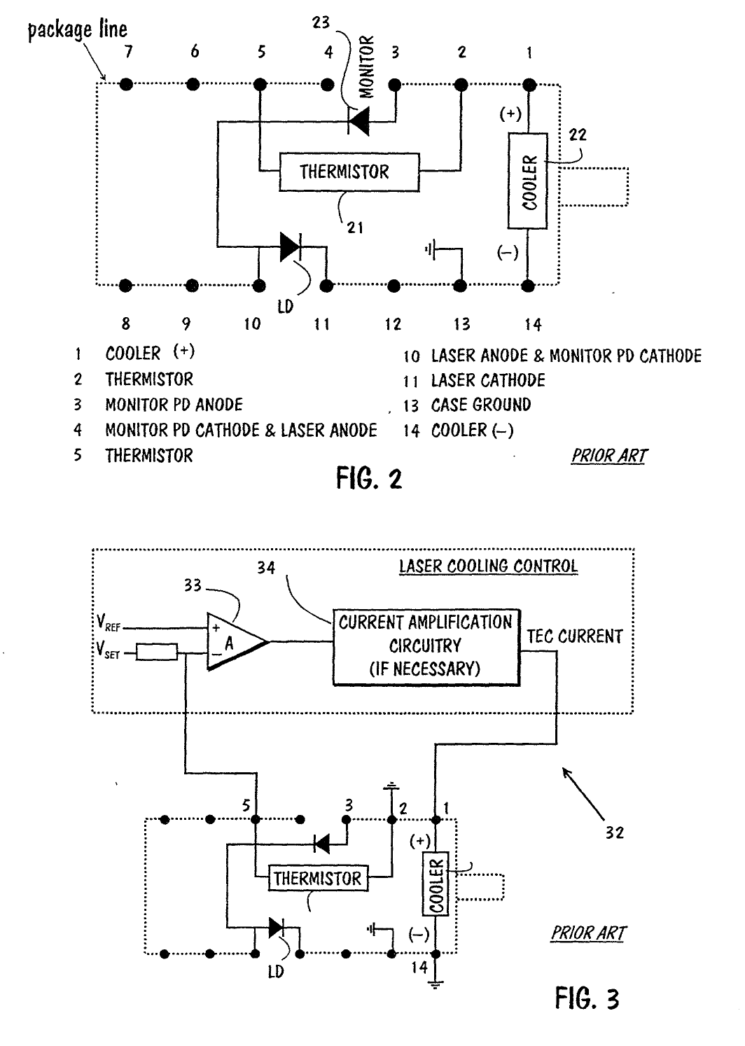

### DETAILED DESCRIPTION OF THE INVENTION

To fully understand the principle of the connection in accordance with the invention, let us return to the temperature dependence of the laser wavelength. When a laser is operating at the rated temperature specified by the manufacturer, it generates light on the wavelength, N. If the electrical values given by the manufacturer hold true, the wavelength should remain at its nominal value even if the ambient temperature, or more precisely, the external temperature, T_{CASE}, of the component case, was to vary within a range, typically of 0° C., . . . , +70° C. because the thermistor causes the cooler to cool or heat the laser. On the other hand, the wavelength generated by the laser chip is known to depend on the laser temperature, T_{LASER}. With commonly used DFB lasers, typical dependency is in the region of +0.08 nm/° C. What is also known is that although the laser temperature remains stable according to the measurements performed by the thermistor, its wavelength is affected not only by the control voltage and current generated by the laser driver circuit that regulates the power generated by the laser but also by the modulator bias levels that determine the scope of the modulation range. The modulation range refers to the difference in the intensities of the light generated by the laser when the “1” bit and the “0” bit are being transmitted. The average laser output is in the mid-point of these two states, so that laser intensity vacillates under and above this level.

Now, the laser wavelength is changed by changing the laser temperature. If the WDM channel raster complies with the ITU-T standard of 100 GHz, the difference in wavelengths between two adjacent channels is 0.8 nm. The laser temperature is changed at least so much that the wavelength switches to the wavelength of the adjacent channel. According to the temperature dependency discussed above, a change of about 10° C. in the laser temperature is enough to shift its wavelength to an adjacent channel.

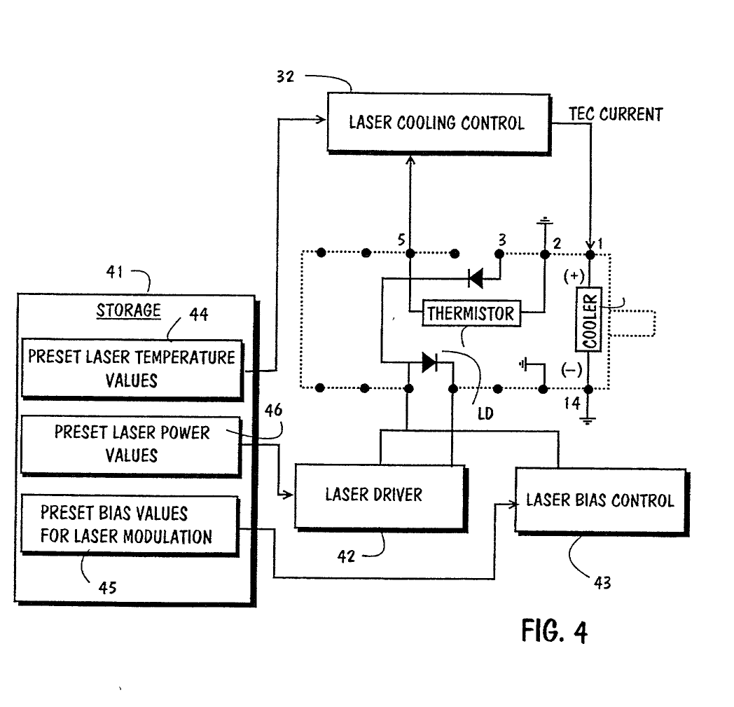

FIG. 4 shows a simplified laser transmitter completed with the additional feature according to the invention. The example shows a laser chip that uses OOK (On-Off-Keying). The laser power is controlled by laser driver circuit 42 in accordance with a known method. The mid-point of the modulation range is set in laser bias control circuit 43, the upper limit of the said range representing maximum laser intensity corresponding to the bit 1 and the lower limit representing the minimum intensity and corresponding to the bit 0. The modulation range can be set to the maximum, in which case bit 0 switches the laser off completely.

In accordance with the invention, the desired temperature values, laser power values, and bias values are stored in non-volatile storage 41. The values are placed in queues each of which contains one temperature value, one laser power value, and a bias value or values. The queue format is {Tᵢ, Pᵢ, bᵢ}, where i=1 . . . k. In reality, there are normally only two queues (k=2), as will be explained later.

One queue at a time can be retrieved from storage and the related values activated to control transmitter operation. The temperature value, Ti, is fed to laser cooling control circuit 32 in response to a value indicating that the laser is to be cooled or heated to the temperature indicated by the value. The power value, Pi, is fed to laser driver 42 that sets the laser power to the pre-set value. The bias value or values, Bi, are fed to the laser bias control circuit that sets the modulation range.

Thus, for each queue, there is an accurately defined pre-set laser temperature and wavelength. The wavelength is changed by retrieving the selected queue from storage and feeding the values contained in it to the transmitter.

The values to be saved in storage are determined by the equipment manufacturer by connecting the necessary measuring devices to the transmitter card. Let us assume that the laser is first set to operate at the nominal temperature indicated by the manufacturer, such as +25° C., in which case the wavelength is, say, 1550.12 nm. Operating points of cooling control circuit, values of laser driver 42 and bias control circuit 43 are adjusted to ensure that the wavelength is exactly right. Then, the values Tᵢ, Pᵢ, bᵢ so obtained are saved in storage. In this example, the temperature value is the value of the laser cooler circuit reference voltage.

Next, new values Tⱼ, Pⱼ, bⱼ are determined that generate a second wavelength, such as 1549.32 nm, and the set of parameters producing the correct wavelength is saved in storage.

In this example, the laser switched to the wavelength of the adjacent channel, which is equivalent to a 0.8 nm difference in wavelength. If the dependence of the laser wavelength on temperature is +0.08 nm/° C., this means that the laser temperature was reduced by around 10° C. and it is now operating at a temperature of 15° C.

A wavelength higher than the rated wavelength can also be selected. Let us select 1550.92 nm, which is a neighbouring channel to the rated wavelength channel. Now the laser temperature must be increased by about 10° C.

It is advisable to only save in storage the wavelength value of the channel directly above or below the nominal wavelength. This is because if we deviate more than that from the rated temperature, the laser temperature will change too much relative to the temperature range within which the manufacturer guarantees that it will work. Another limiting factor is the laser's service life which is shortened when the operating temperature is constantly higher or lower than the rated value indicated by the manufacturer. When the laser operates within a temperature range of +20 . . . +40° C., its service life is assumed to be around 20 years.

Naturally, any wavelength values can be selected within the permitted temperature range. In reality, it may be preferable to select the rated wavelength of the laser chip involved and a second wavelength that is just above or below the rated value. Once the values corresponding to these wavelengths have been saved in storage, it is easy to change the laser wavelength by retrieving from storage the values corresponding to either wavelength. Retrieval can be pre-programmed or carried out manually during operation. To a professional, the implementation of retrieval is obvious.

The values used in the practical example given above are just indicative, and the exact figures can be found in the manufacturer's specifications. The laser used as an example is a DFB laser that uses direct modulation, but the invention is not limited to this type of laser; instead, a laser with an external modulator may also be used. With this type of DFB laser, the laser itself is not switched off at all but on-off modulation is carried out by opening and closing the dimmer placed in front of the laser. After all, the basic idea with the invention is that, in addition to actual temperature regulation, the values of all the electrical quantities that affect laser temperature and wavelength are regulated. The necessary control parameters are saved in storage.

1. A method to change the wavelength of an optical transmitter in a system that uses wavelength division multiplexing, where
the temperature of a laser diode, whose wavelength depends on its temperature, is measured by means of a thermistor placed near the laser diode and the temperature is regulated by means of a cooler,
the temperature control circuit sends, in response to any departure from the pre-set temperature as measured by the thermistor, a control signal to the laser cooler to heat or cool the laser diode,
characterized in that
pre-set temperature values corresponding to the desired wavelengths are saved in storage in advance including the values of the electric quantities that essentially affect the temperature of the laser, and
to switch the laser to another wavelength:
a pre-set temperature value corresponding to the desired wavelength is retrieved from storage including the values of the electric quantities associated with this value,
and the values are fed to the transmitter to control its operation.

2. A method in accordance with claim 1, characterized in that the electric quantities consist of the power value supplied to the laser by the laser driver circuit and the modulator bias values.

3. A method in accordance with claim 1, characterized in that values corresponding to the nominal laser wavelength and values corresponding to at least one wavelength other than the nominal wavelength are saved in storage.

4. A coupling to change the wavelength of a transmitter in an optical transmission system using wavelength division multiplexing, said transmitter comprising
a laser diode (LD), where the wavelength of the light generated depends on the temperature (T_{LASER}) of the laser diode which is monitored by a thermistor (41) placed near the laser diode;
an external control circuit (31), which, in response to a deviation from the set temperature (T_{NTC}) detected by the thermistor, sends a control signal (TEC),
a cooler that, in response to the control signal (TEC), either heats or cools the laser diode;
characterized in that the coupling incorporates a storage (41), into which pre-set temperature values corresponding to desired wavelengths and electric quantities that essentially affect the laser temperature are stored,
a means for retrieving a pre-set temperature value corresponding to a desired wavelength and the values of the electric quantities associated with the pre-set temperature and feeding them to the transmitter to change the wavelength to the wavelength determined by the retrieved values.

5. A coupling in accordance with claim 5, characterized in that
the laser control circuit, in response to the pre-set temperature value retrieved from storage and fed to an external control circuit, causes changes in cooler control (TEC).

6. A coupling in accordance with claim 5, characterized in that the electric quantity stored in the storage is the laser driver values.

7. A coupling in accordance with claim 5, characterized in that the electric quantities saved in storage are the bias values retrieved from the storage and fed to the laser from the modulator.
